(19) United States
(12) Patent Application Publication
(10) Pub. No.: US 2026/0093100 A1
(43) Pub. Date: Apr. 2, 2026

(54) MICROSCOPE SYSTEM AND MOTORIZED NOSEPIECE DRIVING METHOD

(71) Applicant: Evident Corporation, Kamiina-gun (JP)

(72) Inventors: Masaya ABE, Kamiina-gun (JP); Hideaki ENDO, Kamiina-gun (JP)

(73) Assignee: Evident Corporation, Kamiina-gun (JP)

(21) Appl. No.: 19/333,384

(22) Filed: Sep. 19, 2025

(30) Foreign Application Priority Data
Sep. 27, 2024 (JP) 2024-167957
Jul. 2, 2025 (JP) 2025-112167

(51) Int. Cl. G02B 21/02

(52) U.S. Cl. CPC G02B 21/025

(57) ABSTRACT

A microscope system includes: a motorized nosepiece configured to hold a plurality of objective lenses and be able to switch the objective lenses arranged on an observation optical path by rotation; and a processor configured to control driving of the motorized nosepiece in accordance with an input drive instruction, in which the processor has, as a switchable mode for controlling driving of the motorized nosepiece, a first mode for switching the objective lenses arranged on the observation optical path by rotating the motorized nosepiece with a first rotation amount corresponding to the drive instruction, in accordance with the drive instruction, and a second mode for rotating the motorized nosepiece with a second rotation amount in accordance with the drive instruction, and the second rotation amount is smaller than the first rotation amount.

### CROSS REFERENCE TO RELATED APPLICATIONS

This application is based upon and claims the benefit of priority of the prior Japanese Patent Applications No. 2024-167957, filed Sep. 27, 2024, and No. 2025-112167, filed Jul. 2, 2025, the entire contents of which are incorporated herein by reference.

### BACKGROUND OF THE INVENTION

### Field of the Invention

The disclosure of the present specification relates to a microscope system and a motorized nosepiece driving method.

### Description of the Related Art

In recent years, microscopes have been widely used in research in the biological field, inspection processes in the industrial field, and the like.

In routine work such as an inspection process in an industrial field, switching of an observation magnification of a microscope and the like are performed. In such routine work, it is important to efficiently switch the observation magnification in order to shorten the work time.

Therefore, a motorized nosepiece that electrically switches the observation magnification (objective lens) is introduced, and the work time is shortened. While the work time is shortened by the introduction of the motorized nosepiece, the objective lens may interfere with (or collide with) a sample (or a stage) on the stage during switching of the observation magnification, and there is an increasing demand for preventing such interference. In view of such circumstances, various techniques capable of preventing interference between an objective lens and a sample on a stage during switching of observation magnification in a microscope including a motorized nosepiece have been proposed.

For example, JP 3-296707 A discloses a microscope that stops rotation of a motorized nosepiece when an emergency switch is turned ON during the rotation of the motorized nosepiece (during switching of observation magnification). According to this, in a case where the interference between an objective lens and a sample on a stage is predicted during the rotation of the motorized nosepiece, the rotation of the motorized nosepiece can be quickly stopped by operating the emergency switch, so that the interference between the objective lens and the sample on the stage can be avoided.

### SUMMARY OF THE INVENTION

According to an aspect of the present invention, a microscope system that observes a sample with a microscope includes: a motorized nosepiece configured to hold a plurality of objective lenses and be able to switch the objective lenses arranged on an observation optical path by rotation; and a processor configured to control driving of the motorized nosepiece in accordance with an input drive instruction, in which the processor has, as a switchable mode for controlling driving of the motorized nosepiece, a first mode for switching the objective lenses arranged on the observation optical path by rotating the motorized nosepiece with a first rotation amount corresponding to the drive instruction, in accordance with the drive instruction, and a second mode for rotating the motorized nosepiece with a second rotation amount in accordance with the drive instruction, and the second rotation amount is smaller than the first rotation amount.

According to another aspect of the present invention, there is provided a motorized nosepiece driving method for causing a computer to execute a process including: receiving an input of a drive instruction for a motorized nosepiece that holds a plurality of objective lenses and is able to switch the objective lenses arranged on an observation optical path by rotation; switching, in a case where a mode is switched to a first mode, the objective lenses arranged on the observation optical path by rotating the motorized nosepiece with a first rotation amount corresponding to the input drive instruction, in accordance with the drive instruction; and rotating, in a case where the mode is switched to a second mode, the motorized nosepiece with a second rotation amount in accordance with the input drive instruction, in which the second rotation amount is smaller than the first rotation amount.

### BRIEF DESCRIPTION OF THE DRAWINGS

FIG. 1 is a diagram illustrating a configuration of a microscope system according to a first embodiment;

FIG. 2 is a diagram illustrating a front of an operation section;

FIG. 3 is a diagram illustrating the operation section and a motorized nosepiece unit in more detail;

FIG. 4 is a diagram illustrating a positional relationship between an objective lens held by a motorized nosepiece and a sample placed on a stage;

FIG. 5 is a flowchart illustrating a flow of JOG mode processing according to the first embodiment;

FIG. 6 is a flowchart illustrating a flow of JOG mode processing according to a second embodiment;

FIG. 7 is a diagram illustrating a state where an optical axis of the objective lens arranged on an observation optical path is inclined with respect to an axis perpendicular to a sample placement surface by an inclination mechanism;

FIG. 8 is another diagram illustrating the front of the operation section;

FIG. 9 is a diagram illustrating a hardware configuration of a computer that implements a control device;

FIG. 10 is a diagram illustrating a motorized nosepiece having four attachment holes to which an objective lens is attached;

FIG. 11 is a diagram illustrating an example of screen transition of a nosepiece position screen;

FIG. 12 is a diagram illustrating an example of screen transition of another nosepiece position screen;

FIG. 13 is another diagram illustrating the front of the operation section;

FIG. 14 is a flowchart illustrating control processing performed by the control device;

FIG. 15 is a diagram illustrating an example of a section between adjacent objective lenses;

FIG. 16 is a diagram illustrating a table for storing information;

FIG. 17 is a diagram illustrating an example of rotation of the motorized nosepiece;

FIG. 18 is a diagram illustrating an example of update of the table; and

FIG. 19 is a flowchart illustrating control processing performed by the control device.

### DESCRIPTION OF THE EMBODIMENTS

In the microscope of JP 3-296707 A, when a timing at which the objective lens can be predicted to interfere with the sample on the stage during the rotation of the motorized nosepiece is immediately before the objective lens interferes with the sample on the stage, the operation of the emergency switch is not in time, and it is not possible to avoid the interference, in some cases.

In addition, during switching to an objective lens having a short working distance (WD), it is not easy to determine whether or not the objective lens interferes with the sample on the stage until immediately before, in some cases. Depending on the shape of the sample on the stage (such as a shape having a height difference or a complicated shape), in some cases, it is not easy to determine whether or not the objective lens interferes with the sample on the stage until immediately before.

Embodiments of the present invention will be described below with reference to the drawings.

### First Embodiment

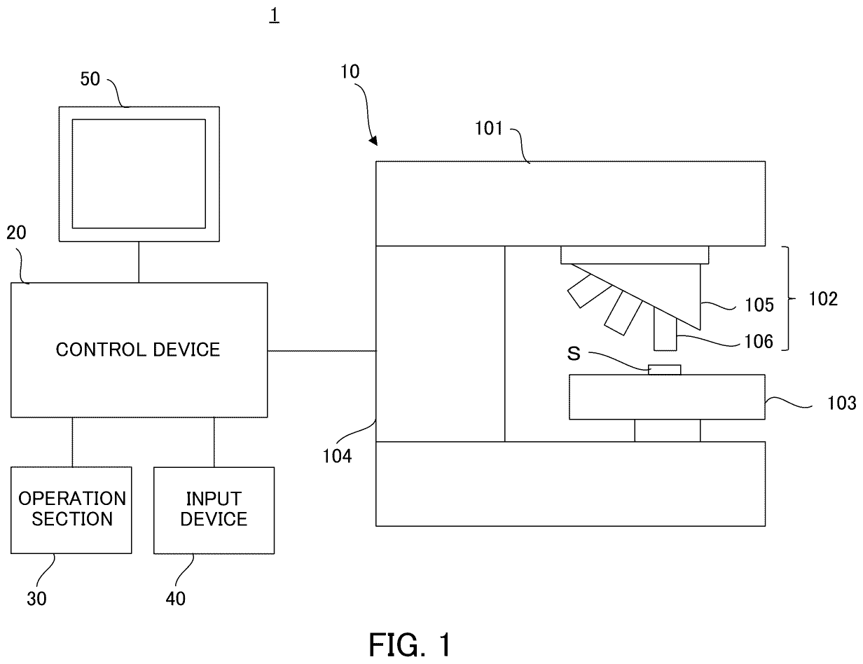

FIG. 1 is a diagram illustrating a configuration of a microscope system according to a first embodiment.

A microscope system 1 illustrated in FIG. 1 is a system used in, for example, an inspection process in an industrial field. The microscope system 1 includes a microscope 10, a control device 20, an operation section 30, an input device 40, and a display device 50.

The microscope 10 is, for example, a digital microscope, and includes a microscope head 101, a motorized nosepiece unit 102, a stage 103, and a microscope frame 104.

The microscope head 101 includes a light source that emits illumination light with which a sample S is irradiated, an image capturing unit that captures an observation image of the sample S, and the like. The light source is, for example, a white light emitting diode (LED), a halogen lamp, or a xenon lamp. The image capturing unit is, for example, a charge coupled device (CCD) image sensor, a complementary metal oxide semiconductor (CMOS) image sensor, or the like.

The motorized nosepiece unit 102 is attached to the microscope head 101. The motorized nosepiece unit 102 includes a motorized nosepiece 105. The motorized nosepiece 105 holds a plurality of objective lenses 106, and can switch the objective lens 106 arranged on an observation optical path by rotation. The motorized nosepiece 105 rotates when the control device 20 drives a stepping motor 107 for the motorized nosepiece, which will be described later.

The sample S is placed on the stage 103. The stage 103 moves in a direction perpendicular to an optical axis of the objective lens 106 arranged on the observation optical path. The stage 103 may further move in an optical axis direction of the objective lens 106 arranged on the observation optical path. The stage 103 is, for example, an electric stage, and moves when the control device 20 drives a stepping motor for the stage.

The microscope frame 104 is provided with the stage 103 and holds the microscope head 101 to be movable in the optical axis direction of the objective lens 106 arranged on the observation optical path. The microscope head 101 moves, for example, electrically, and moves when the control device 20 drives a stepping motor for the microscope head. In a case where the stage 103 is movable in the optical axis direction of the objective lens 106 arranged on the observation optical path, the microscope head 101 may be fixed and held by the microscope frame 104.

The control device 20 is, for example, a computer, and controls each unit of the microscope system 1. For example, the control device 20 controls driving (rotation) of the motorized nosepiece 105, movement of the microscope head 101, movement of the stage 103, display of the display device 50, or the like in accordance with an input of an instruction received by the operation section 30 or the input device 40.

The control device 20 has an observation mode and a JOG mode as switchable modes for controlling the driving of the motorized nosepiece 105. The observation mode is an example of a first mode, and is a mode for switching the objective lens 106 arranged on the observation optical path in accordance with the input drive instruction. The JOG mode is an example of a second mode, and is a mode for rotating the motorized nosepiece 105 in accordance with the input drive instruction. As a result, any one of the objective lenses 106 can be quickly arranged on the observation optical path in a case where the mode is switched to the observation mode, and the motorized nosepiece 105 can be freely rotated in a case where the mode is switched to the JOG mode.

The operation section 30 receives an input of a drive instruction for the motorized nosepiece 105 or the like from a user. Details of the operation section 30 will be described later. The input device 40 receives various inputs from the user. The input device 40 includes, for example, a mouse and a keyboard.

The display device 50 displays various screens and an observation image of the sample S. The observation image of the sample S is an image obtained in a manner that the image capturing unit provided in the microscope head 101 captures the observation image of the sample S. Examples of the display device 50 include a liquid crystal display and an organic electroluminescence (EL) display. The display device 50 may be a touch panel display or may also serve as the input device 40.

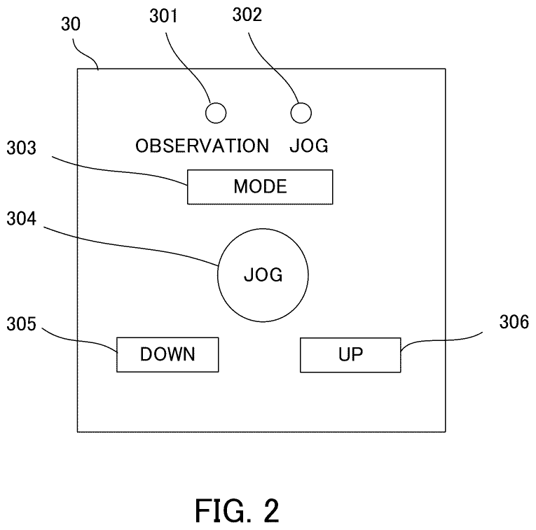

FIG. 2 is a diagram illustrating a front of the operation section.

The operation section 30 illustrated in FIG. 2 includes an observation mode light emitting diode (LED) 301, a JOG mode LED 302, a mode (MODE) switching button switch 303, a JOG dial 304, a magnification down (DOWN) button switch 305, and a magnification up (UP) button switch 306 on the front.

The observation mode LED 301 is an LED that emits light only in a case where the control device 20 is switched to the observation mode. The JOG mode LED 302 is an LED that emits light only in a case where the control device 20 is switched to the JOG mode.

A mode switching button switch 303 is a button switch that receives an input of a mode switching instruction. The JOG dial 304 is an example of a dial type operation member, and receives an input of a drive instruction for the motorized nosepiece 105 only in a case where the control device 20 is switched to the JOG mode. The magnification down button switch 305 is a button switch that receives an input of a magnification down instruction as the drive instruction for the motorized nosepiece 105 only in a case where the control device 20 is switched to the observation mode. The magnification up button switch 306 is a button switch that receives an input of a magnification up instruction as the drive instruction for the motorized nosepiece 105 only in a case where the control device 20 is switched to the observation mode. The magnification down button switch 305 and the magnification up button switch 306 are examples of two magnification change direction instruction members.

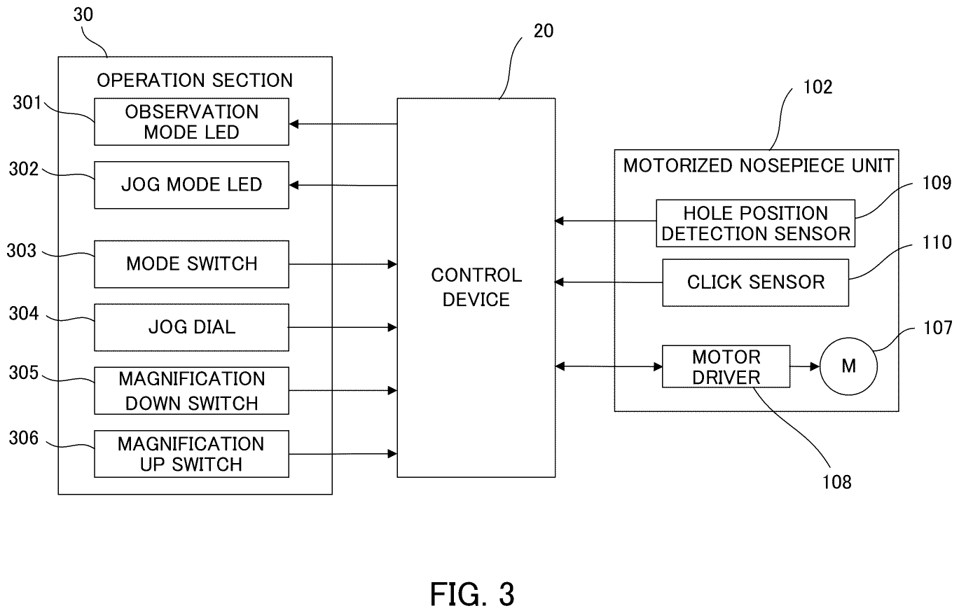

FIG. 3 is a diagram illustrating the operation section and the motorized nosepiece unit in more detail.

In the operation section 30, light emission/extinction of the observation mode LED 301 and light emission/extinction of the JOG mode LED 302 are controlled by the control device 20.

When the mode switching button switch (MODE switch) 303 is pressed, an ON signal of the button switch is input to the control device 20 as the mode switching instruction. When the mode switching instruction is input, the control device 20 switches the mode switched until that time to the other mode. For example, in a case where the mode switched until that time is the observation mode, the mode is switched to the JOG mode.

The JOG dial 304 includes, for example, a two-phase rotary encoder. When a rotation operation of the JOG dial 304 is performed in a case where the control device 20 is switched to the JOG mode, an operation signal corresponding to the rotation operation is input to the control device 20 as the drive instruction for the motorized nosepiece 105. When the drive instruction is input, the control device 20 outputs a drive signal to a motor driver 108 that drives a stepping motor 107 that rotates the motorized nosepiece 105 so that the motorized nosepiece 105 rotates by a predetermined amount in a rotation direction and at a rotation speed corresponding to the drive instruction. As a result, when the JOG dial 304 is rotated slowly, the motorized nosepiece 105 also rotates slowly, and when the JOG dial 304 is rotated quickly, the motorized nosepiece 105 also rotates quickly. An upper limit may be provided for the rotation speed of the motorized nosepiece 105 at this time. For example, in a case where the rotation speed of the JOG dial 304 is a predetermined value or more, a drive signal may be output to the motor driver 108 so that the rotational speed of the motorized nosepiece 105 is limited to the upper limit value. The stepping motor 107 and the motor driver 108 are provided in the motorized nosepiece unit 102.

When the magnification down button switch (magnification DOWN switch) 305 is pressed in a case where the control device 20 is switched to the observation mode, an ON signal of this button switch is input to the control device 20 as the magnification down instruction. When the magnification down instruction is input, the control device 20 outputs a drive signal to the motor driver 108 that drives the stepping motor 107 that rotates the motorized nosepiece 105 so that the objective lens 106 arranged on the observation optical path up to that time is switched to the objective lens 106 having a lower magnification. In a case where the objective lens 106 having a lower magnification is not held by the motorized nosepiece 105, the objective lens 106 is not switched.

When the magnification up button switch (magnification UP switch) 306 is pressed in a case where the control device 20 is switched to the observation mode, an ON signal of this button switch is input to the control device 20 as the magnification up instruction. When the magnification up instruction is input, the control device 20 outputs a drive signal to the motor driver 108 that drives the stepping motor 107 that rotates the motorized nosepiece 105 so that the objective lens 106 arranged on the observation optical path up to that time is switched to the objective lens 106 having a higher magnification. In a case where the objective lens 106 having a higher magnification is not held by the motorized nosepiece 105, the objective lens 106 is not switched.

The motorized nosepiece unit 102 includes a hole position detection sensor 109 that detects the position of an attachment hole of the motorized nosepiece 105 to which the objective lens 106 arranged on the observation optical path is attached and outputs the detection result to the control device 20. The control device 20 retains, in advance, information regarding the magnification of the objective lens 106 attached to each attachment hole of the motorized nosepiece 105 and information regarding the rotation amount of the motorized nosepiece 105 necessary for switching to the objective lens 106 attached to each attachment hole. Therefore, when the magnification down button switch 305 or the magnification up button switch 306 is pressed, the control device 20 can determine in which direction and by which amount the motorized nosepiece 105 is preferably rotated, or whether or not the objective lens 106 having a lower magnification or higher magnification is held by the motorized nosepiece 105.

The motorized nosepiece unit 102 includes a click sensor 110. The click sensor 110 is a sensor that detects whether or not any of the objective lenses 106 held by the motorized nosepiece 105 is arranged on the observation optical path, and outputs the detection result to the control device 20.

Next, an operation of the microscope system 1 will be described.

When the user turns on the microscope system 1, the control device 20 switches to the observation mode, and causes the observation mode LED 301 to emit light and turns off the JOG mode LED 302.

Then, the user places a sample S as an observation target on the stage 103. It is assumed that the observation image of the sample S displayed on the display device 50 is confirmed, it is determined that increase or decrease of magnification is necessary, and the magnification up button switch 306 or the magnification down button switch 305 is pressed. Then, the control device 20 switches the objective lens 106 arranged on the observation optical path up to that time to the objective lens 106 having a higher magnification or a lower magnification in accordance with the pressed button switch. As described above, in a case where the mode is switched to the observation mode, the objective lens 106 arranged on the observation optical path can be quickly switched by pressing the magnification up button switch 306 or the magnification down button switch 305.

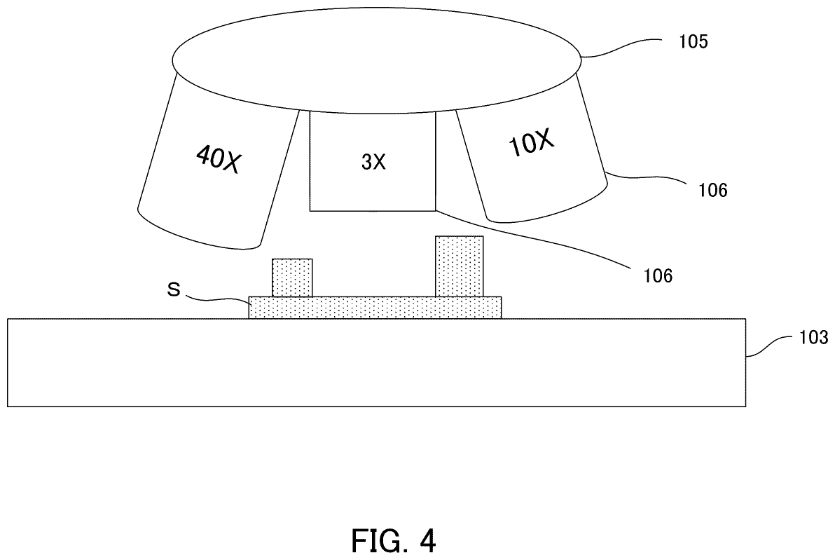

In some cases, the user wants to confirm whether or not the objective lens 106 interferes with the sample S placed on the stage 103, before switching the objective lens 106. For example, this is a case where the positional relationship between the objective lens 106 held by the motorized nosepiece 105 and the sample S placed on the stage 103 is the positional relationship illustrated in FIG. 4, and the objective lens 106 that has a magnification of three times (3×) and is arranged on the observation optical path is to be switched to the objective lens 106 having a magnification of ten times (10×). At a time point before the objective lens 106 is switched, it is not easy to determine whether or not the objective lens 106 having a magnification of ten times (10×) interferes with the sample S during the switching of the objective lens 106.

Therefore, it is assumed that the mode switching button switch 303 is pressed in order for the user to determine whether or not the interference occurs, in advance. Then, the control device 20 switches the observation mode to the JOG mode, turns off the observation mode LED 301, and causes the JOG mode LED 302 to emit light. The control device 20 starts JOG mode processing. The JOG mode processing is processing performed while the mode is switched to the JOG mode, and ends when the mode is switched to the observation mode by pressing the mode switching button switch 303 again.

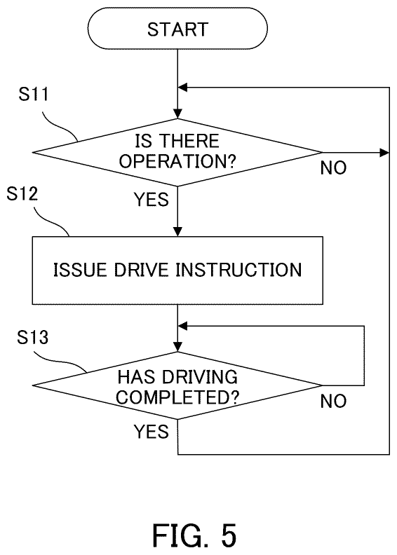

FIG. 5 is a flowchart illustrating a flow of the JOG mode processing.

As illustrated in FIG. 5, when the JOG mode processing is started, the control device 20 determines whether or not there is an operation (rotation operation) of the JOG dial 304 in S11. This determination also means to determine whether or not a drive instruction (an operation signal corresponding to a rotation operation of the JOG dial 304) has been input from the JOG dial 304.

The determination process of S11 is repeated until the determination result in S11 becomes YES. When the determination result in S11 is YES, the control device 20 issues a drive instruction for the motorized nosepiece 105 in accordance with the drive instruction input from the JOG dial 304 in S12. More specifically, the control device 20 outputs a drive signal corresponding to a drive instruction input from the JOG dial 304 to the motor driver 108. As a result, the stepping motor 107 is driven, and the motorized nosepiece 105 rotates. The drive signal output to the motor driver 108 is a signal for rotating the motorized nosepiece 105 by a predetermined amount in a rotation direction and at a rotation speed corresponding to the drive instruction input from the JOG dial 304. Needless to say, the predetermined amount at this time is smaller than the rotation amount of the motorized nosepiece 105 in a case where the mode is switched to the observation mode, and the objective lens 106 is switched in response to the pressing of the magnification up button switch 306 or the magnification down button switch 305. Here, the predetermined amount is an example of a second rotation amount. The rotation amount of the motorized nosepiece 105 in a case where the mode is switched to the observation mode, and the objective lens 106 is switched in response to the pressing of the magnification up button switch 306 or the magnification down button switch 305 is an example of a first rotation amount.

Then, in S13, the control device 20 determines whether or not driving of the motorized nosepiece 105 in accordance with the drive instruction, which has been performed in S12, has completed. This determination also means to determine whether or not a driving completion signal is input from the motor driver 108. When the driving in accordance with the drive signal input from the control device 20 is completed, the motor driver 108 outputs a driving completion signal to the control device 20.

The determination process of S13 is repeated until the determination result in S13 becomes YES. When the determination result in S13 becomes YES, the processing returns to S11, and it is determined again whether or not the JOG dial 304 is operated.

According to such JOG mode processing, for example, when the user slowly rotates the JOG dial 304 in the CW direction (clockwise direction) or the CCW direction (counterclockwise direction), the motorized nosepiece 105 also slowly rotates in the CW direction or the CCW direction. When the user stops the rotation operation, the rotation of the motorized nosepiece 105 is also stopped. Therefore, the user can determine whether or not the objective lens 106 interferes with the sample S on the stage 103 in advance by slowly rotating the JOG dial 304. In a case where it is determined that the objective lens 106 interferes with the sample S on the stage 103, the interference between the objective lens 106 and the sample S can be prevented by, for example, raising the microscope head 101 or lowering the stage 103 before switching the objective lens 106.

In a case where it is determined that the objective lens 106 does not interfere with the sample S on the stage 103 and the mode is switched from the JOG mode to the observation mode in a state where the objective lens 106 is not arranged on the observation optical path, the control device 20 may rotate the motorized nosepiece 105 until any objective lens 106 is arranged on the observation optical path based on the detection result of the click sensor 110.

### Second Embodiment

A second embodiment differs from the first embodiment in the content of JOG mode processing.

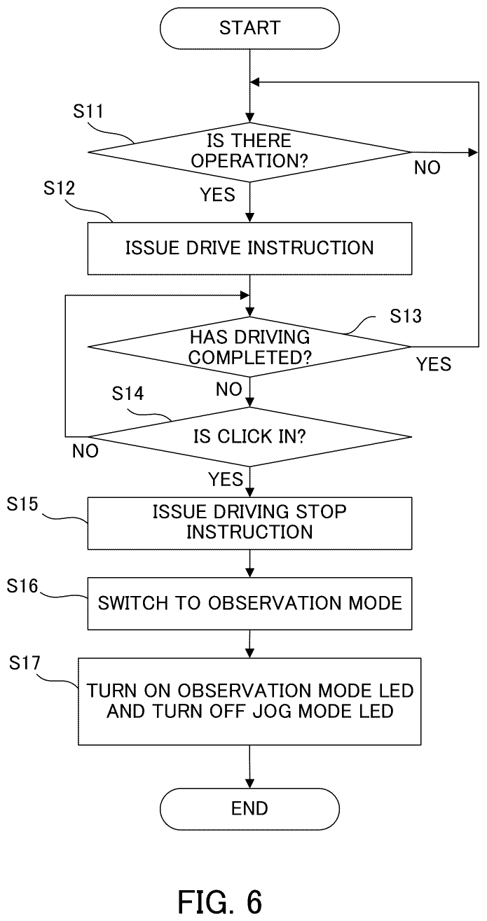

FIG. 6 is a flowchart illustrating a flow of JOG mode processing according to the second embodiment.

The processes of S11 to S13 in the JOG mode processing illustrated in FIG. 6 are the same as the JOG mode processing illustrated in FIG. 5, but the JOG mode processing illustrated in FIG. 6 is different from the JOG mode processing illustrated in FIG. 5 in that the processes of S14 and the subsequent steps are further executed in a case where the determination result in S13 is NO.

Specifically, in a case where the determination result in S13 is NO, the control device 20 determines whether or not click is IN in S14. This determination also means to determine whether or not the click sensor 110 has detected that any of the objective lenses 106 held by the motorized nosepiece 105 is arranged on the observation optical path.

In a case where the determination result in S14 is NO, the processing returns to S13 and it is determined again whether or not the driving of the motorized nosepiece 105 has completed. On the other hand, in a case where the determination result in S14 is YES, the control device 20 issues a driving stop instruction for the motorized nosepiece 105 in S15. More specifically, the control device 20 outputs a drive stop signal to the motor driver 108. As a result, the driving of the stepping motor 107 is stopped, and the rotation of the motorized nosepiece 105 is stopped.

Then, the control device 20 switches from the JOG mode to the observation mode in S16, and turns on the observation mode LED 301 and turns off the JOG mode LED 302 in S17. When the process of S17 ends, the JOG mode processing ends.

According to such JOG mode processing, the following effects can be obtained in addition to the effects described in the first embodiment. For example, assuming a case where the objective lens 106 arranged on the observation optical path is switched to the desired objective lens 106, in a case where the user causes the motorized nosepiece 105 to rotate by the rotation operation of the JOG dial 304 and can determine that the desired objective lens 106 does not interfere with the sample S, the desired objective lens 106 can be arranged on the observation optical path by continuing the rotation operation of the JOG dial 304 as it is. As a result, it is possible to perform switching to the desired objective lens 106 without pressing the mode switching button switch 303, and the magnification down button switch 305 or the magnification up button switch 306, whereby it is possible to smoothly perform the shift to the observation work.

### Third Embodiment

A third embodiment is different from the first embodiment in that the microscope 10 further includes an inclination mechanism.

The inclination mechanism is a mechanism capable of inclining the optical axis of the objective lens 106 arranged on the observation optical path with respect to an axis perpendicular to the sample placement surface of the stage 103 so that the sample S can be obliquely observed. For example, the inclination mechanism inclines a part of the microscope frame 104 holding the microscope head 101 to incline the optical axis of the objective lens 106 arranged on the observation optical path with respect to the axis perpendicular to the sample placement surface. The inclination mechanism is electrically driven, for example, and the control device 20 drives a stepping motor for inclination to drive the inclination mechanism. The inclination mechanism includes an inclination sensor that detects inclination (presence or absence of inclination and an inclination angle) by the inclination mechanism and outputs the detection result to the control device 20.

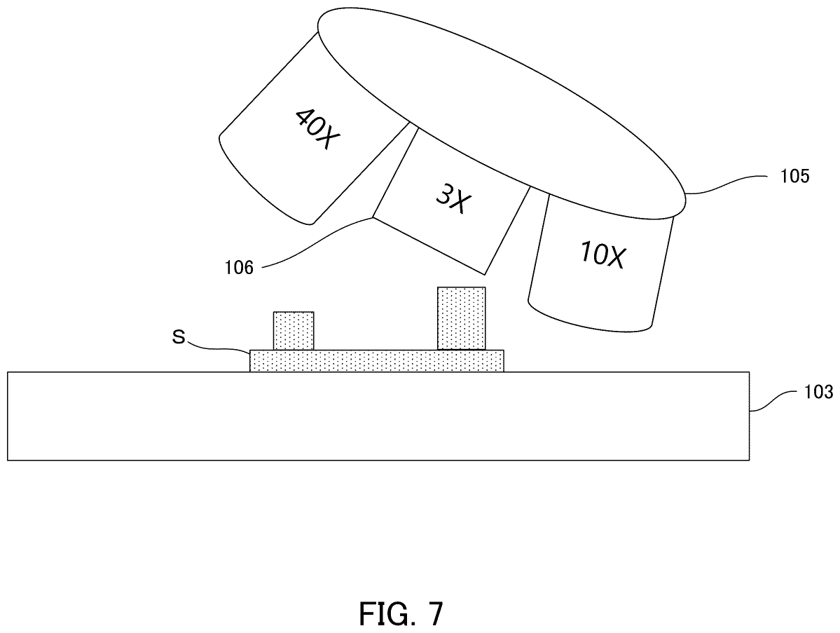

FIG. 7 is a diagram illustrating a state where the optical axis of the objective lens arranged on the observation optical path is inclined with respect to the axis perpendicular to the sample placement surface by the inclination mechanism.

As illustrated in FIG. 7, in a state where the optical axis of the objective lens 106 (in FIG. 7, the objective lens 106 having a magnification of three times (3×)) arranged on the observation optical path is inclined with respect to the axis perpendicular to the sample placement surface of the stage 103 (also simply referred to as an “inclined state” below), there is a high concern that the objective lens 106 interferes with the sample S (or the stage 103) on the stage 103 when the objective lens 106 arranged on the observation optical path is switched.

Therefore, when detecting the inclination (presence of inclination or inclination angle other than 0 degrees) by the inclination mechanism, the control device 20 switches to the JOG mode, then turns off the observation mode LED 301, and causes the JOG mode LED 302 to emit light.

As described above, since the mode is automatically switched to the JOG mode in the inclined state, the input of the magnification down instruction or the magnification up instruction by pressing the magnification down button switch 305 or the magnification up button switch 306 is not received. Therefore, even if the magnification down button switch 305 or the magnification up button switch 306 is pressed due to an erroneous operation, the objective lens 106 is not switched, so that it is possible to avoid interference between the objective lens 106 and the sample S (or the stage 103) that may occur at the time of switching.

The above embodiments are specific examples for facilitating the understanding of the invention, and the present invention is not limited to these embodiments. Variations of the embodiments described above and alternatives to the embodiments described above may be included. That is, in the above-described embodiments, the components can be modified without departing from the spirit and scope thereof. In addition, a new embodiment can be implemented by appropriately combining a plurality of components disclosed in the above-described embodiments. Furthermore, some components may be omitted from among the components described in the embodiments, or some components may be added to the components described in the embodiments. Furthermore, the order of the processing procedures described in the embodiments may be changed as long as there is no contradiction. In other words, the system and the method of the present invention can be variously modified and altered without departing from the scope as recited by the claims.

For example, in the first embodiment, in the operation section 30, instead of including the magnification down button switch 305 and the magnification up button switch 306, the JOG dial 304 may further receive the input of the magnification down instruction and the input of the magnification up instruction.

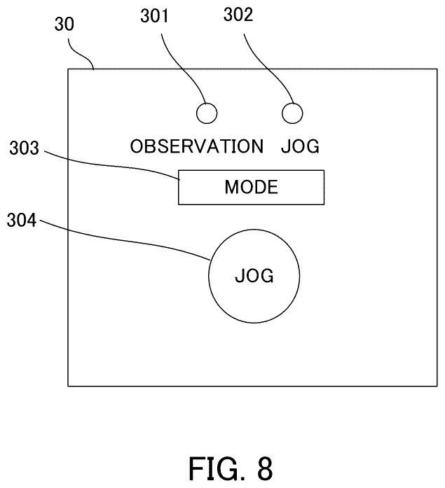

FIG. 8 is another diagram illustrating the front of the operation section.

The operation section 30 illustrated in FIG. 8 is different from the operation section 30 illustrated in FIG. 2 in that the magnification down button switch 305 and the magnification up button switch 306 are not provided. In the operation section 30 illustrated in FIG. 8, in a case where the mode is switched to the observation mode, the input of the magnification up instruction or the magnification down instruction is received in accordance with the rotation operation direction (CW direction or CCW direction) of the JOG dial 304.

According to such a modification example, driving of the motorized nosepiece 105 for determining whether or not the objective lens 106 interferes with the sample S and driving of the motorized nosepiece 105 for switching the objective lens 106 arranged on the observation optical path can be performed only by the operation of the JOG dial 304. Therefore, it is possible to improve operability in a case where determination as to whether or not the objective lens 106 interferes with the sample S and switching of the objective lens 106 arranged on the observation optical path are repeatedly performed. In routine work such as an inspection process in which the microscope system 1 is used, it is important to quickly perform the magnification change operation to shorten the work time, and thus such a modification example is effective.

For example, in the second embodiment, the motorized nosepiece 105 is driven in response to the operation of the JOG dial 304 in a case where the mode is switched to the JOG mode, but may be driven in response to the operation of the magnification down button switch 305 or the magnification up button switch 306. More specifically, while the magnification down button switch 305 or the magnification up button switch 306 is pressed, the motorized nosepiece 105 may rotate at a constant low speed in the CW direction or the CCW direction, and when the pressing is stopped, the rotation of the motorized nosepiece 105 may be stopped. Here, the low speed is at least a speed lower than the rotation speed of the motorized nosepiece 105 when the objective lens 106 is switched in the observation mode.

For example, in each embodiment, the microscope system 1 may be used in a biological field. In this case, for example, in a state where the mode is switched to the JOG mode by pressing the mode switching button switch 303, the motorized nosepiece 105 is alternately rotated by a small amount in the CW direction and the CCW direction by operating the JOG dial 304 to perform air removal work inside the immersion when an immersion objective lens is used.

Furthermore, for example, in each embodiment, the operation section 30 may include a button switch corresponding to each attachment hole of the motorized nosepiece 105 instead of the magnification down button switch 305 and the magnification up button switch 306. For example, in a case where the motorized nosepiece 105 has four attachment holes, four button switches corresponding to the respective attachment holes may be provided. When any one of the button switches is pressed in a case where the mode is switched to the observation mode, the control device 20 may control driving of the motorized nosepiece 105 such that the objective lens 106 arranged on the observation optical path is switched to the objective lens 106 attached to the attachment hole corresponding to the pressed button switch.

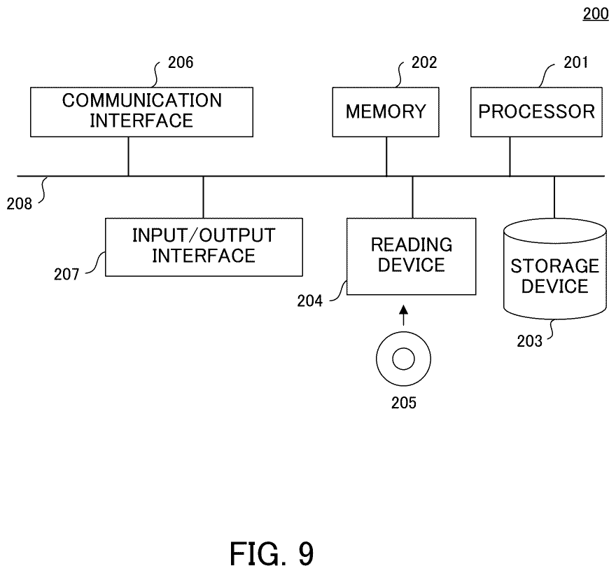

In each embodiment, the control device 20 may be implemented by a computer illustrated in FIG. 9.

FIG. 9 is a diagram illustrating a hardware configuration of a computer that implements the control device.

A computer 200 illustrated in FIG. 9 includes a processor 201, a memory 202, a storage device 203, a reading device 204, a communication interface 206, and an input/output interface 207 as hardware. The processor 201, the memory 202, the storage device 203, the reading device 204, the communication interface 206, and the input/output interface 207 are connected to each other, for example, via a bus 208.

The processor 201 may be, for example, a single processor, a multiprocessor, or a multi-core processor. The processor 201 reads and executes programs stored in the storage device 203 to perform various types of control processing including the above-described JOG mode processing, and provides a function as the control device 20 of the microscope system 1.

The memory 202 is, for example, a semiconductor memory and may include a RAM area and a ROM area. The “RAM” is an abbreviation for a random access memory, and the “ROM” is an abbreviation for a read only memory.

For example, the storage device 203 is a hard disk, a semiconductor memory such as a flash memory, or an external storage device. The storage device 203 stores information regarding the magnification of the objective lens 106 attached to each attachment hole of the motorized nosepiece 105, information regarding the rotation amount of the motorized nosepiece 105 necessary for switching to the objective lens 106 attached to each attachment hole, and the like.

The reading device 204 accesses a removable recording medium 205, for example, according to an instruction of the processor 201. For example, the removable recording medium 205 is achieved by a semiconductor device, a medium to/from which information is input/output by a magnetic action, a medium to/from which information is input/output by an optical action. The semiconductor device is, for example, a Universal Serial Bus (USB) memory. The medium to which information is input and output by the magnetic effect is, for example, a magnetic disk. The medium to and from which information is input and output by an optical action is, for example, a compact disc (CD)-ROM, a digital versatile disk (DVD), or a Blu-ray (registered trademark) disc, or the like.

The communication interface 206 is connected to a communication network and communicates with other devices (for example, a server or the like), for example, in accordance with an instruction of the processor 201. The input/output interface 207 is an interface with, for example, the microscope 10, the operation section 30, the input device 40, and the display device 50.

For example, the program executed by the processor 201 is provided to the computer 200 in the following forms:
(1) installed in the storage device 203 in advance;
(2) provided by the removable recording medium 205; and
(3) provided from a server such as a program server.

The hardware configuration of the computer 200 for implementing the control device 20, the computer 200 being described with reference to FIG. 9, is an example, and the embodiments are not limited to this. For example, a part of the configuration described above may be omitted or a new configuration may be added to the configuration described above. For example, some or all functions of the control device 20 may be implemented as hardware. A field programmable gate array (FPGA), a system-on-a-chip (SoC), an application specific integrated circuit (ASIC), and a programmable logic device (PLD) are examples of hardware by which the control device 20 can be implemented.

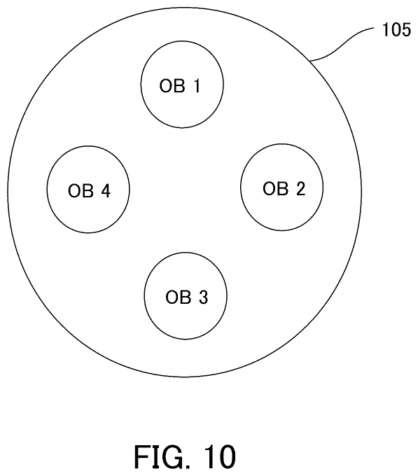

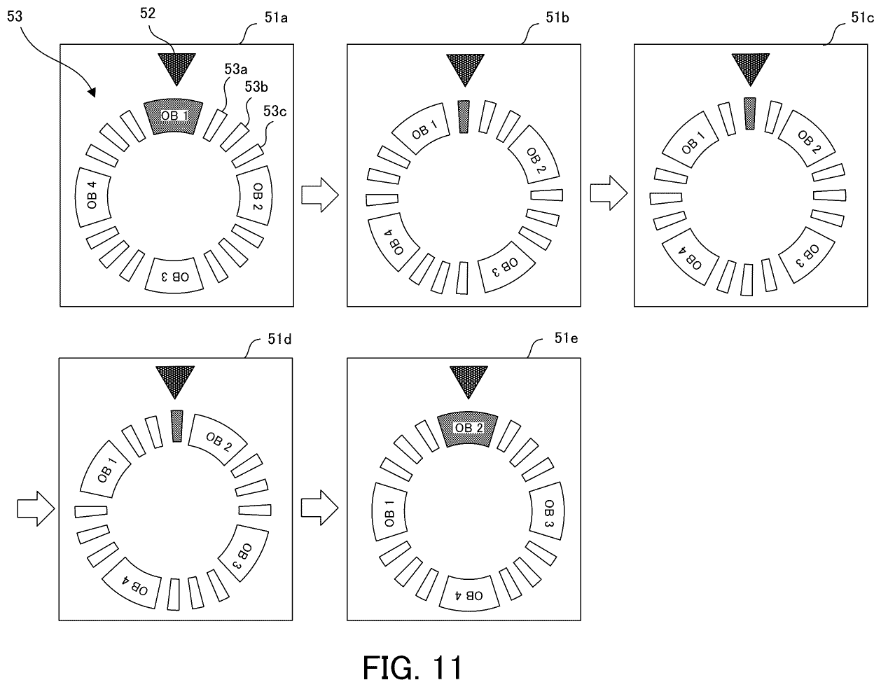

In each embodiment, in a case where the mode is switched to the JOG mode, a nosepiece position screen showing the current rotational position of the motorized nosepiece 105 may be displayed on the display device 50. Such a modification example will be described with reference to FIGS. 10 and 11.

FIG. 10 is a diagram illustrating the motorized nosepiece having four attachment holes to which the objective lens is attached. FIG. 11 is a diagram illustrating an example of screen transition of the nosepiece position screen.

For example, as illustrated in FIG. 10, it is assumed that the motorized nosepiece 105 has four attachment holes of “OB1”, “OB2”, “OB3”, and “OB4”, and the objective lens 106 is attached to each of the attachment holes. In this case, when the mode is switched to the JOG mode, the control device 20 causes the display device 50 to display (for example, pop-up display) a nosepiece position screen 51 (for example, 51a) illustrated in FIG. 11. On the nosepiece position screen 51, a mark 52 indicating the position of the observation optical path and an object 53 imitating the motorized nosepiece 105 are displayed. The object 53 includes a plurality of regions. The plurality of regions include regions (regions of “OB1”, “OB2”, “OB3”, and “OB4”) corresponding to the positions of the four attachment holes and regions (for example, regions 53a, 53b, and 53c) corresponding to respective sections obtained by equally dividing spaces between the respective attachment holes adjacent to each other in the rotation direction into three sections. Such an object 53 is displayed such that the region corresponding to the position of the motorized nosepiece 105 arranged on the observation optical path is pointed by the mark 52 and is distinguishable from other regions by color or the like.

For example, in a case where the objective lens 106 attached to the attachment hole of “OB1” is arranged on the observation optical path, the nosepiece position screen 51a is displayed. On the nosepiece position screen 51a, a region (region of “OB1”) corresponding to the position of the attachment hole of “OB1” is displayed to be pointed by the mark 52 and distinguishable from other regions by color. Thereafter, for example, assuming that the user performs a rotation operation on the JOG dial 304 until the objective lens 106 attached to the attachment hole of “OB2” is arranged on the observation optical path, the nosepiece position screen 51 transitions from the nosepiece position screen 51a to nosepiece position screens 51b, 51c, 51d, and 51e in this order. That is, on the nosepiece position screen 51, along with the rotation of the motorized nosepiece 105 by the rotation operation on the JOG dial 304, the object 53 is rotationally displayed, and the region of the object 53 corresponding to the position of the motorized nosepiece 105 arranged on the observation optical path is sequentially displayed to be distinguishable from other regions.

According to such a modification example, in a case where the mode is switched to the JOG mode, the user can check the rotation position of the motorized nosepiece 105 in real time.

In such a modification example, the control device 20 can detect the position of the attachment hole to which the objective lens 106 arranged on the observation optical path is attached, with the hole position detection sensor 109. The control device 20 recognizes the rotation direction and the rotation amount of the motorized nosepiece 105 by one drive instruction (S12) in the JOG mode processing illustrated in FIG. 5, for example. Thus, the control device 20 can recognize the current rotation position of the motorized nosepiece 105 based on the position of the attachment hole to which the objective lens 106 arranged on the observation optical path is attached and the drive instruction (S12) performed thereafter.

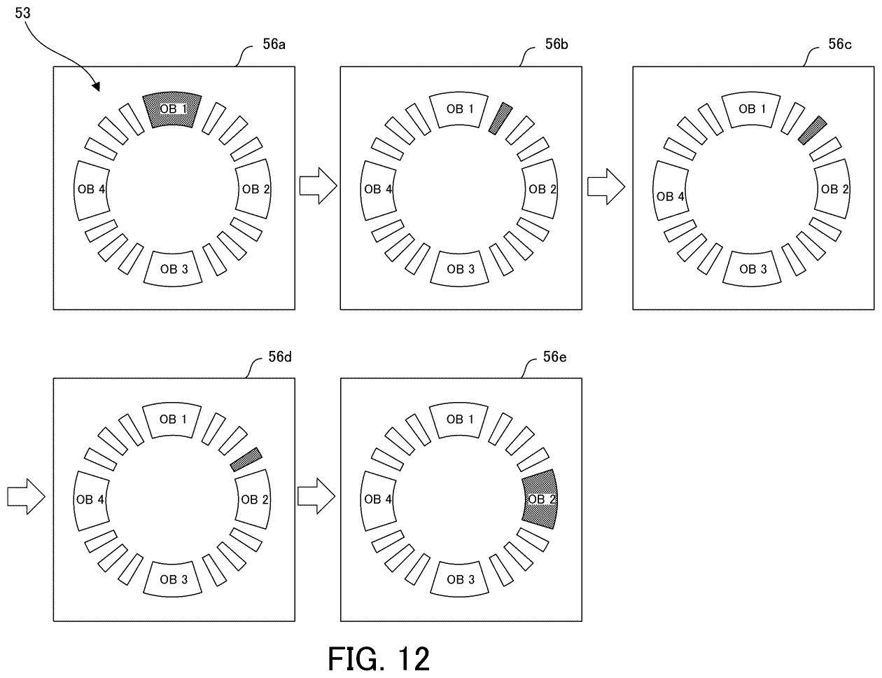

The nosepiece position screen showing the current rotation position of the motorized nosepiece 105 is not limited to the form of the nosepiece position screen 51 described with reference to FIG. 11, and may be, for example, the form of a nosepiece position screen 56 illustrated in FIG. 12.

FIG. 12 is a diagram illustrating an example of screen transition of another nosepiece position screen.

The nosepiece position screen 56 illustrated in FIG. 12 is the same as the nosepiece position screen 51 illustrated in FIG. 11 in that the region of the object 53 corresponding to the position of the motorized nosepiece 105 arranged on the observation optical path is displayed to be distinguishable from other regions by color or the like, but is different from the nosepiece position screen 51 illustrated in FIG. 11 in that the object 53 is not rotationally displayed and is fixedly displayed and the mark 52 is not displayed.

As a result, for example, in a case where the objective lens 106 attached to the attachment hole of “OB1” is arranged on the observation optical path, a nosepiece position screen 56a is displayed. On the nosepiece position screen 56a, a region (region of “OB1”) corresponding to the position of the attachment hole of “OB1” is displayed to be distinguishable from other regions by color. Thereafter, for example, assuming that the user performs a rotation operation on the JOG dial 304 until the objective lens 106 attached to the attachment hole of “OB2” is arranged on the observation optical path, the nosepiece position screen 56 transitions from the nosepiece position screen 56a to nosepiece position screens 56b, 56c, 56d, and 56e in this order. That is, on the nosepiece position screen 56, along with the rotation of the motorized nosepiece 105 by the rotation operation on the JOG dial 304, the region of the object 53 corresponding to the position of the motorized nosepiece 105 arranged on the observation optical path is sequentially displayed to be distinguishable from other regions.

With such a nosepiece position screen 56, the user can also check the rotation position of the motorized nosepiece 105 in real time.

Instead of the nosepiece position screen 56 displayed on the display device 50, for example, a nosepiece position display panel may be provided in front of the operation section 30. The nosepiece position display panel has, for example, a plurality of regions having a shape like the object 53 on the nosepiece position screen 56, and each region is configured to be able to emit light by an LED. For example, in a case where the objective lens 106 attached to the attachment hole of “OB1” is arranged on the observation optical path, the corresponding region in the nosepiece position display panel emits light by the LED, like the object 53 in the nosepiece position screen 56a of FIG. 12. Thereafter, for example, assuming that the user performs a rotation operation on the JOG dial 304 until the objective lens 106 attached to the attachment hole of “OB2” is arranged on the observation optical path, the corresponding region in the nosepiece position display panel sequentially emits light by the LED so that the nosepiece position screen 56 in FIG. 12 transitions from the nosepiece position screen 56a to the nosepiece position screens 56b, 56c, 56d, and 56e in this order. That is, in the nosepiece position display panel, the region corresponding to the position of the motorized nosepiece 105 arranged on the observation optical path sequentially emits light along with the rotation of the motorized nosepiece 105 by the rotation operation on the JOG dial 304.

With such a nosepiece position display panel, the user can also check the rotation position of the motorized nosepiece 105 in real time.

Next, another modification example will be described.

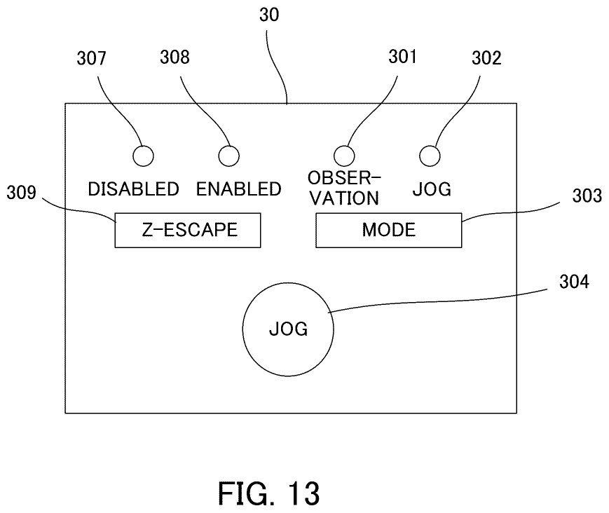

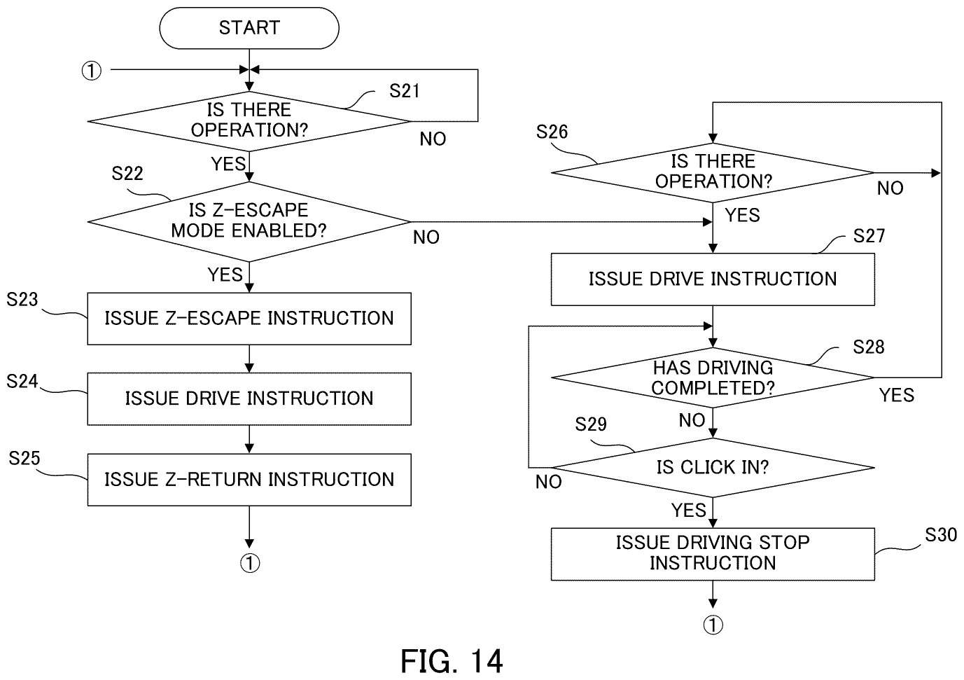

The operation section 30 illustrated in FIG. 8 described above may be further modified, and the control device 20 may perform control processing of the motorized nosepiece 105 in accordance with an operation on the operation section 30. Such a modification example will be described with reference to FIGS. 13 and 14.

FIG. 13 is another diagram illustrating the front of the operation section.

The operation section 30 illustrated in FIG. 13 further includes a Z-escape disabled LED 307, a Z-escape enabled LED 308, and a Z-escape mode switching button switch 309 in addition to the components of the operation section 30 illustrated in FIG. 8. The Z-escape disabled LED 307 is an LED that emits light only in a case where the Z-escape mode is disabled. The Z-escape enabled LED 308 is an LED that emits light only in a case where the Z-escape mode is enabled. The Z-escape mode switching button switch 309 is a button for receiving an input of an instruction to switch the Z-escape mode between being enabled and disabled.

In a case where the microscope system 1 includes the operation section 30 illustrated in FIG. 13, when the microscope system 1 is powered on, the control device 20 switches the Z-escape mode to be enabled, turns off the Z-escape disabled LED 307, and causes the Z-escape enabled LED 308 to emit light. Thereafter, every time the Z-escape mode switching button switch 309 is pressed, the Z-escape mode is alternately switched between being enabled and disabled. In a case where the Z-escape mode is switched to be disabled, the Z-escape disabled LED 307 is caused to emit light and the Z-escape enabled LED 308 is turned off. In a case where the Z-escape mode is switched to be enabled, the Z-escape disabled LED 307 is turned off and the Z-escape enabled LED 308 is caused to emit light.

In a case where the Z-escape mode is switched to be enabled, the control device 20 switches to the observation mode, and causes the observation mode LED 301 to emit light and causes the JOG mode LED 302 to be turned off. In a case where the Z-escape mode is switched to be disabled, the control device 20 switches to the JOG mode, and causes the observation mode LED 301 to be turned off and causes the JOG mode LED 302 to emit light. As described above, the control device 20 also switches between the observation mode and the JOG mode in accordance with switching between the enabled state and the disabled state of the Z-escape mode.

The control device 20 performs control processing illustrated in FIG. 14 in accordance with the enabled state or disabled state of the Z-escape mode and the operation on the JOG dial 304.

FIG. 14 is a flowchart illustrating the control processing performed by the control device.

When the control processing illustrated in FIG. 14 is started, the control device 20 determines whether or not there is an operation (rotation operation) on the JOG dial 304 in S21. The process of S21 is similar to the process of S11 (for example, S11 in FIG. 6).

In a case where the determination result in S21 is YES, the control device 20 determines whether or not the Z-escape mode is enabled in S22. This determination also means to determine whether or not the mode is the observation mode (whether the mode is the observation mode or the JOG mode).

In a case where the determination result in S22 is YES (in a case where the Z-escape mode is enabled), the control device 20 issues a Z-escape instruction for the microscope head 101 and/or the stage 103 in S23. The Z-escape means that the microscope head 101 and/or the stage 103 are moved so that the microscope head 101 and the stage 103 are separated from each other in the optical axis direction (Z-direction) of the objective lens 106 arranged on the observation optical path to such an extent that the objective lens 106 held by the motorized nosepiece 105, and the stage 103 or the sample S placed on the stage 103 do not interfere with each other before the motorized nosepiece 105 rotates.

After S23, in S24, the control device 20 issues a drive instruction for the motorized nosepiece 105 in accordance with the operation (rotation operation) of the JOG dial 304 determined in S21. The drive instruction at this time is a drive instruction for rotating the motorized nosepiece 105 in a direction corresponding to the rotation direction (CW direction or CCW direction) of the JOG dial 304 and switching the objective lens 106 arranged on the observation optical path to the adjacent objective lens 106.

After S24, the control device 20 issues a Z-return instruction for the microscope head 101 and/or the stage 103 in S25. The Z-return means to move the microscope head 101 and/or the stage 103 so as to bring the positional relationship between the microscope head 101 and the stage 103 back to the state before the Z-escape.

As described above, in a case where the Z-escape mode is enabled, when the JOG dial 304 is operated, the Z-escape, switching of the objective lens 106, and the Z-return are performed. Thus, the objective lens 106, and the stage 103 or the sample S do not interfere with each other during the switching of the objective lens 106.

After S25, the processing returns to S21.

On the other hand, in a case where the determination result in S22 is NO (in a case where the Z-escape mode is disabled), the processing proceeds to S27. Since the processes of S26 to S30 including the process of S27 are the same as the processes of S11 to S15 in FIG. 6, the description thereof will be omitted here. The processes of S11 to S15 in FIG. 6 are a part of the JOG mode processing described in the second embodiment.

As described above, in a case where the Z-escape mode is disabled, the JOG mode processing described in the second embodiment is performed, and thus it is possible to obtain the similar effect to that of the second embodiment.

After S30, the processing returns to S21.

Next, other modification examples will be described.

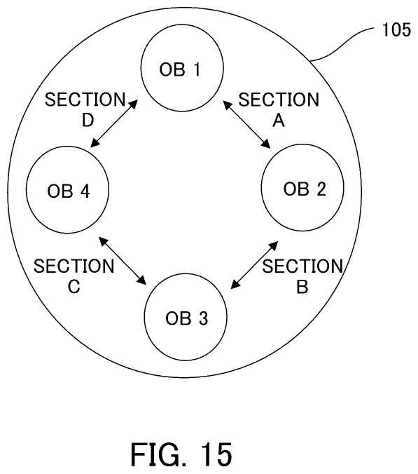

In a case where the microscope system 1 includes the operation section 30 illustrated in FIG. 8, the control device 20 may perform control processing of the motorized nosepiece 105 based on the information stored in a table (lookup table). The table stores information such as whether or not the observation optical path has passed through a section between the adjacent objective lenses by driving the motorized nosepiece 105 in the JOG mode. Such a modification example will be described in detail with reference to FIGS. 15 to 19.

FIG. 15 is a diagram illustrating an example of the section between the adjacent objective lenses.

In the example illustrated in FIG. 15, similarly to the motorized nosepiece 105 illustrated in FIG. 10, it is assumed that the motorized nosepiece 105 has four attachment holes of “OB1”, “OB2”, “OB3”, and “OB4”, and the objective lens 106 is attached to each of the attachment holes. A “section A” indicates a section (which is also a section between “OB1” and “OB2”) between the objective lens 106 attached to “OB1” and the objective lens 106 attached to “OB2”. A “section B” indicates a section (which is also a section between “OB2” and “OB3”) between the objective lens 106 attached to “OB2” and the objective lens 106 attached to “OB3”. A “section C” indicates a section (which is also a section between “OB3” and “OB4”) between the objective lens 106 attached to “OB3” and the objective lens 106 attached to “OB4”. A “section D” indicates a section (which is also a section between “OB4” and “OB1”) between the objective lens 106 attached to “OB4” and the objective lens 106 attached to “OB1”.

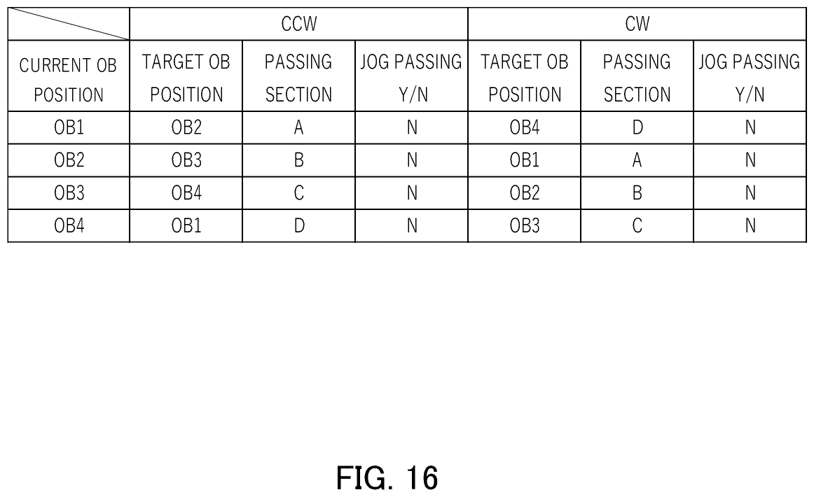

FIG. 16 is a diagram illustrating the table for storing information.

In the table illustrated in FIG. 16, for each “current OB position”, “target OB position”, “passing section”, and “JOG passing Y/N” in the case of “CCW”, and “target OB position”, “passing section”, and “JOG passing Y/N” in the case of “CW” are stored.

The “current OB position” indicates the attachment hole of the objective lens 106 currently arranged on the observation optical path. For example, a case where the “current OB position” is “OB1” indicates that the attachment hole of the objective lens 106 currently arranged on the observation optical path is “OB1”.

The “target OB position” in the case of “CCW” indicates the attachment hole of the objective lens 106 to be arranged next on the observation optical path in a case where the motorized nosepiece 105 rotates in the CCW direction. The “target OB position” in the case of “CW” indicates the attachment hole of the objective lens 106 to be arranged next on the observation optical path in a case where the motorized nosepiece 105 rotates in the CW direction. For example, in a case where the “current OB position” is “OB1”, the “target OB position” in the case of “CCW” is “OB2”, and the “target OB position” in the case of “CW” is “OB4”.

The “passing section” in the case of “CCW” indicates a section (which is also a section through which the observation optical path passes) between the “current OB position” and the “target OB position” in the case of “CCW”. The “passing section” in the case of “CW” indicates a section (which is also a section through which the observation optical path passes) between the “current OB position” and the “target OB position” in the case of “CW”. For example, in a case where the “current OB position” is “OB1”, the “passing section” in the case of “CCW” is the “section A” between “OB1” that is the “current OB position” and “OB2” that is the “target OB position”, and the “passing section” in the case of “CW” is the “section D” between “OB1” that is the “current OB position” and “OB4” that is the “target OB position”.

“JOG passing Y/N” in the case of “CCW” indicates whether or not the observation optical path has passed through the “passing section” in the case of “CCW” in the JOG mode. “JOG passing Y/N” in the case of “CW” indicates whether or not the observation optical path has passed through the “passing section” in the case of “CW” in the JOG mode. “Y” indicates that the observation optical path has passed, and “N” indicates that the observation optical path has not passed. For example, in the case where the “current OB position” is “OB1”, “JOG passing Y/N” in the case of “CCW” being “N” indicates that the observation optical path does not pass through the “section A” which is the “passing section” in the case of “CCW” in the JOG mode. In the case where the “current OB position” is “OB1”, “JOG passing Y/N” in the case of “CW” being “N” indicates that the observation optical path does not pass through the “section D” which is the “passing section” in the case of “CW” in the JOG mode.

Such a table is stored, for example, in the storage device 203 of the computer 200 illustrated in FIG. 9 that implements the control device 20.

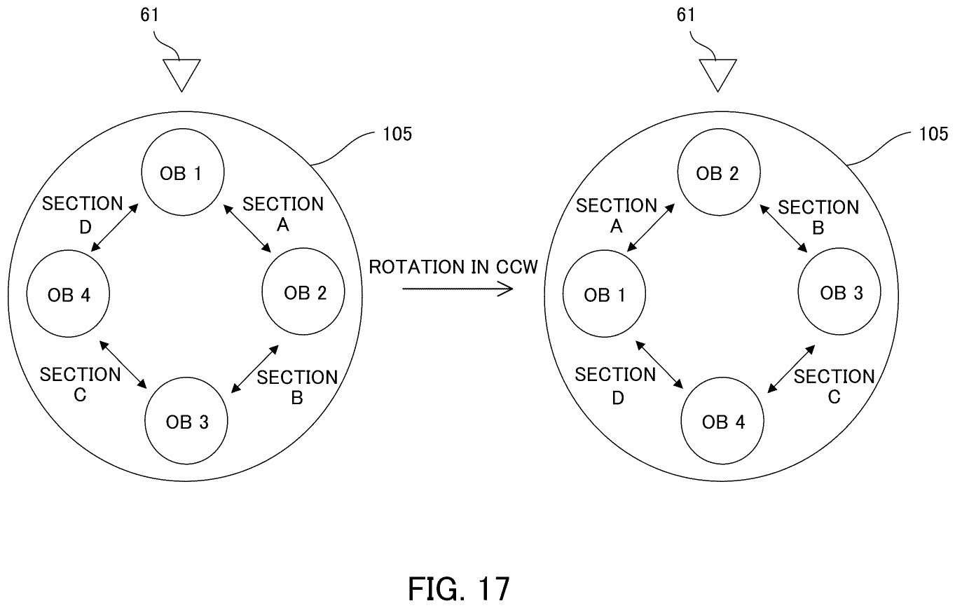

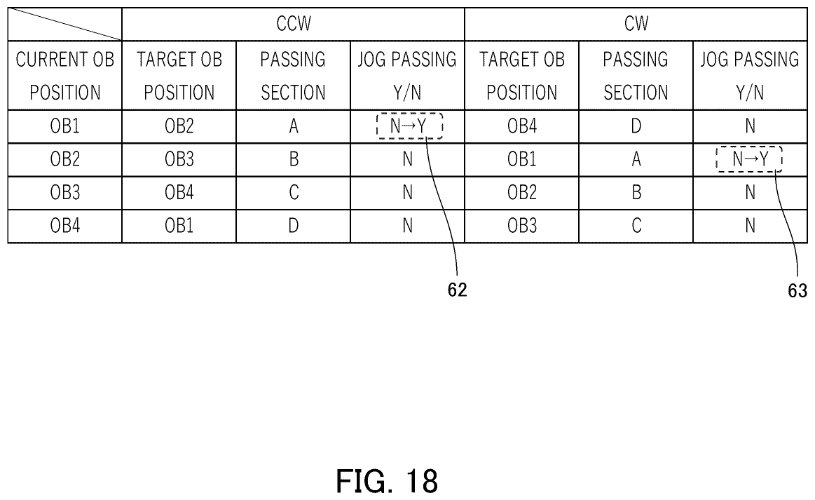

Here, an example of update of “JOG passing Y/N” stored in the table will be described with reference to FIGS. 17 and 18. FIG. 17 is a diagram illustrating an example of rotation of the motorized nosepiece. FIG. 18 is a diagram illustrating an example of update of the table.

For example, in the JOG mode, as illustrated in FIG. 17, it is assumed that the motorized nosepiece 105 rotates in the CCW direction, and the position of the objective lens 106 arranged on the observation optical path is changed from “OB1” to “OB2”. A mark 61 in FIG. 17 points out the observation optical path.

In this case, “OB1” is the “current OB position”, “OB2” is the “target OB position” in the case of “CCW”, and the “section A” between “OB1” and “OB2” is the “passing section”. Therefore, as illustrated in FIG. 18, “JOG passing Y/N” in the case of “CCW” in the case where the “current OB position” is “OB1” is updated from “N” to “Y” (see the broken line frame 62). “JOG passing Y/N” having the same “passing section” in the case of “CW” is similarly updated from “N” to “Y” (see the broken line frame 63). As described above, in the table, when “JOG passing Y/N” in one case of “CCW” and “CW” is updated, “JOG passing Y/N” having the same “passing section” in the other case is similarly updated. This means that the objective lens 106, and the stage 103 or the sample S do not interfere with each other in the switching of the objective lens 106 according to the “passing section” (“section A” in the above example) unless, thereafter, the stage 103 is moved in an XY direction, or the microscope head 101 and/or the stage 103 is moved in the Z-direction. The XY direction is also a direction perpendicular to the optical axis of the objective lens 106 arranged on the observation optical path, and the Z-direction is also the optical axis direction of the objective lens 106 arranged on the observation optical path.

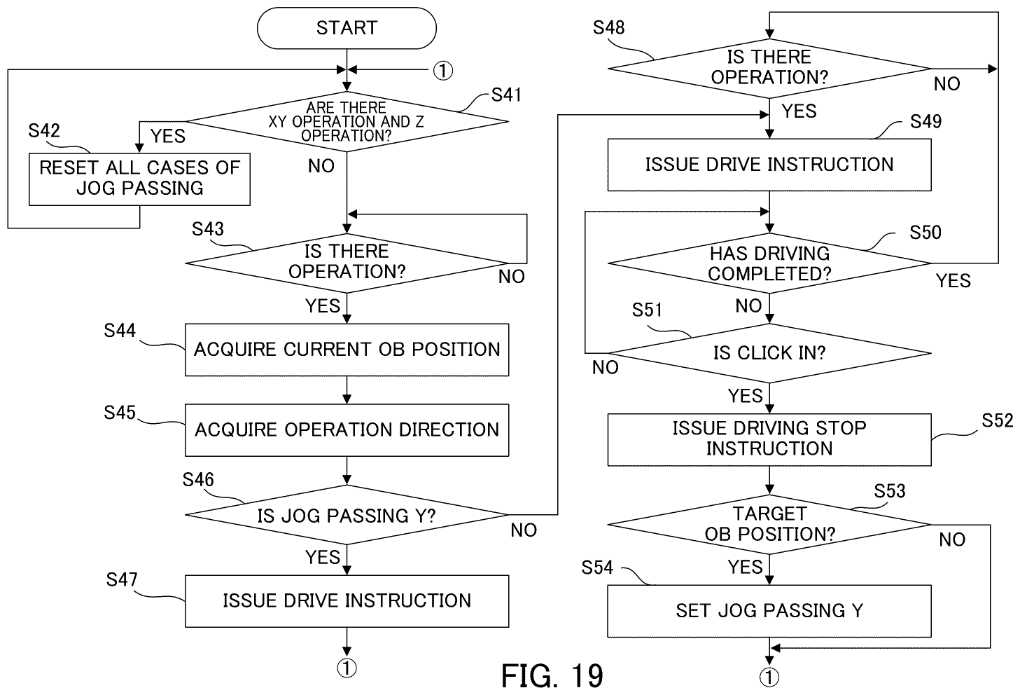

Next, control processing of the motorized nosepiece 105 performed by the control device 20 based on the information stored in the table will be described with reference to FIG. 19.

FIG. 19 is a flowchart illustrating the control processing performed by the control device.

When the control processing illustrated in FIG. 19 is started, the control device 20 determines whether or not there are an XY operation or a Z operation in S41. The XY operation is an operation of moving the stage 103 in the XY direction. The Z operation is an operation of moving the microscope head 101 and/or the stage 103 in the Z-direction.

In a case where the determination result in S41 is YES, the control device 20 resets all cases of “JOG passing Y/N” stored in the table in S42. Resetting all the cases of “JOG passing Y/N” also means setting all the cases of “JOG passing Y/N” to “N”. After S42, the processing returns to S41.

On the other hand, in a case where the determination result in S41 is NO, the control device 20 determines whether or not there is an operation (rotation operation) on the JOG dial 304 in S43. The process of S43 is similar to the process of S11 (for example, S11 in FIG. 6).

In a case where the determination result in S43 is YES, the control device 20 acquires the position of the objective lens 106 that is currently arranged on the observation optical path, in S44, and acquires the direction of the operation (rotation direction of the rotation operation) determined in S43, in S45. In the present example, it is assumed that the motorized nosepiece 105 also rotates in the CCW direction when the JOG dial 304 is rotated in the CCW direction, and the motorized nosepiece 105 also rotates in the CW direction when the JOG dial 304 is rotated in the CW direction.

Then, in S46, the control device 20 refers to the table and determines whether or not “JOG passing Y/N” corresponding to the position of the objective lens 106 acquired in S44 and the direction of the operation acquired in S45 is “Y”. For example, in the table illustrated in FIG. 18, in a case where the position of the objective lens 106 (which is also the “current OB position”) acquired in S44 is “OB1” and the rotation direction of the motorized nosepiece 105 corresponding to the direction of the operation acquired in S45 is “CCW”, the corresponding “JOG passing Y/N” is “Y”, and thus the determination result in S46 is YES.

In a case where the determination result in S46 is YES, the control device 20 switches to the observation mode, and in S47, the control device 20 issues a drive instruction for the motorized nosepiece 105 in accordance with the direction of the operation acquired in S45. The drive instruction at this time is a drive instruction for rotating the motorized nosepiece 105 in a direction corresponding to the direction of the operation acquired in S45 and switching the objective lens 106 arranged on the observation optical path to the adjacent objective lens 106. After S47, the processing returns to S41.

As described above, in a case where the determination result in S46 is YES, it is known that the objective lens 106, and the stage 103 or the sample S do not interfere with each other during the switching of the objective lens 106 at this time, and thus it is possible to quickly switch the objective lens 106.

On the other hand, in a case where the determination result in S46 is NO (in a case where the corresponding “JOG passing Y/N” is “N”), the control device 20 switches to the JOG mode, and the processing proceeds to S49. Since the processes of S48 to S52 including the process of S49 are the same as the processes of S11 to S15 in FIG. 6, the description thereof will be omitted here. The processes of S11 to S15 in FIG. 6 are a part of the JOG mode processing described in the second embodiment.

As described above, in a case where the determination result in S46 is NO, the JOG mode processing described in the second embodiment is performed, and thus it is possible to obtain the similar effect to that of the second embodiment.

After S52, in S53, the control device 20 determines whether or not the position of the objective lens 106 that is currently arranged on the observation optical path is the “target OB position” in the table. The “target OB position” at this time is the “target OB position” in a case where the position acquired in S44 is set as the “current OB position”. For example, in the table illustrated in FIG. 16, in a case where the position acquired in S44 is “OB1”, the “target OB position” is “OB2” or “OB4”.

In a case where the determination result in S53 is YES, the control device 20 sets “Y” to the corresponding “JOG passing Y/N” in the table in S54. The corresponding “JOG passing Y/N” in the table is “JOG passing Y/N” for the “passing section” in a case where the position acquired in S44 is the “current OB position” and the position of the objective lens 106 that is currently arranged on the observation optical path is the “target OB position”. For example, in the table illustrated in FIG. 16, the “passing section” in a case where the position acquired in S44 is “OB1” and the position of the objective lens 106 that is currently arranged on the observation optical path is “OB2” is the “section A”. In this case, as illustrated in FIG. 18, “Y” is set to the corresponding “JOG passing Y/N” for the “section A”. As a result, unless the XY operation or the Z operation is performed thereafter, the objective lens 106 according to the “passing section” can be quickly switched.

After S54, or in a case where the determination result in S53 is NO, the processing returns to S41. The case where the determination result in S53 is NO is, for example, a case where the objective lens is switched to the original objective lens 106 before switching to the adjacent objective lens 106 after the switching of the objective lens 106 is started.

What is claimed is:

1. A microscope system that observes a sample with a microscope, the microscope system comprising:
a motorized nosepiece configured to hold a plurality of objective lenses and be able to switch the objective lenses arranged on an observation optical path by rotation; and
a processor configured to control driving of the motorized nosepiece in accordance with an input drive instruction,
wherein the processor has, as a switchable mode for controlling driving of the motorized nosepiece,
a first mode for switching the objective lenses arranged on the observation optical path by rotating the motorized nosepiece with a first rotation amount corresponding to the drive instruction, in accordance with the drive instruction, and
a second mode for rotating the motorized nosepiece with a second rotation amount in accordance with the drive instruction, and
the second rotation amount is smaller than the first rotation amount.

2. The microscope system according to claim 1,
wherein the processor is further configured to perform switching between the first mode and the second mode in accordance with an input mode switching instruction.

3. The microscope system according to claim 1, further comprising:
a dial type operation member configured to receive an input of the drive instruction,
wherein the processor is further configured to, in a case where the mode is switched to the second mode, rotate the motorized nosepiece in accordance with a rotation operation of the dial type operation member.

4. The microscope system according to claim 1, further comprising:
two magnification change direction instruction members configured to receive an input of the drive instruction,
wherein the processor is further configured to, in a case where the mode is switched to the first mode, switch the objective lens arranged on the observation optical path in accordance with an operation on one of the two magnification change direction instruction members.

5. The microscope system according to claim 1, further comprising:
a sensor configured to detect that the objective lens is arranged on the observation optical path,
wherein the processor is further configured to, in a case where the mode is switched to the second mode, stop driving of the motorized nosepiece when the sensor detects that the objective lens is arranged on the observation optical path during rotation of the motorized nosepiece.

6. The microscope system according to claim 1, further comprising:
a dial type operation member configured to receive an input of the drive instruction,
wherein the processor is further configured to, in a case where the mode is switched to the first mode, switch the objective lens arranged on the observation optical path in accordance with a rotation operation direction of the dial type operation member, and
the processor is further configured to, in a case where the mode is switched to the second mode, rotate the motorized nosepiece in accordance with a rotation operation of the dial type operation member.

7. The microscope system according to claim 1, wherein
the microscope includes an inclination mechanism capable of inclining an optical axis of the objective lens arranged on the observation optical path with respect to an axis perpendicular to a sample placement surface, and
the processor is further configured to, in a case where there is the inclination, switch the mode to the second mode.

8. The microscope system according to claim 1, wherein
the motorized nosepiece is driven by a stepping motor.

9. A motorized nosepiece driving method for causing a computer to execute a process comprising:
receiving an input of a drive instruction for a motorized nosepiece that holds a plurality of objective lenses and is able to switch the objective lenses arranged on an observation optical path by rotation;
switching, in a case where a mode is switched to a first mode, the objective lenses arranged on the observation optical path by rotating the motorized nosepiece with a first rotation amount corresponding to the input drive instruction, in accordance with the drive instruction; and
rotating, in a case where the mode is switched to a second mode, the motorized nosepiece with a second rotation amount in accordance with the input drive instruction,
wherein the second rotation amount is smaller than the first rotation amount.
